(19) United States
(12) Patent Application Publication
(10) Pub. No.: US 2026/0097983 A1
(43) Pub. Date: Apr. 9, 2026

(54) AGITATION STRUCTURES AND AGITATION METHODS

(71) Applicant: CAIHONG DISPLAY DEVICES CO., LTD., Xianyang (CN)

(72) Inventors: Menglong WANG, Xianyang (CN); Hongrong HOU, Xianyang (CN); Wei YANG, Xianyang (CN); Chao YU, Xianyang (CN); Ting LUO, Xianyang (CN)

(73) Assignee: CAIHONG DISPLAY DEVICES CO., LTD., Xianyang (CN)

(21) Appl. No.: 19/415,856

(22) Filed: Dec. 11, 2025

Related U.S. Application Data
(63) Continuation-in-part of application No. PCT/CN2025/115609, filed on Aug. 19, 2025.

(30) Foreign Application Priority Data
Sep. 29, 2024 (CN) 202411374784.4

(51) Int. Cl. C03B 5/187; B01F 27/112; B01F 27/15; B01F 35/22; B01F 35/50; C03B 5/24

(52) U.S. Cl. CPC C03B 5/187; B01F 27/112; B01F 27/15; B01F 35/2209; B01F 35/50; C03B 5/24; B01F 2215/0427; B01F 2215/0431

(57) ABSTRACT

Disclosed herein are an agitation structure and an agitation method. The agitation structure includes an agitation inlet pipe and an agitation tank. The agitation tank includes a buffer pool and an agitation container. The agitation container is communicably installed below the buffer pool. The agitation inlet pipe is communicably installed on a side wall of the buffer pool. The agitation tank is provided with an agitator.

### CROSS-REFERENCE TO RELATED APPLICATIONS

This application is a Continuation-in-part of International Application No. PCT/CN2025/115609, filed on Aug. 19, 2025, which claims priority to Chinese Patent Application No. 202411374784.4, filed on Sep. 29, 2024, the entire contents of each of which are hereby incorporated by reference.

### TECHNICAL FIELD

The present disclosure generally relates to a technology field of substrate glass production, and in particular to an agitation structure and an agitation method.

### BACKGROUND

The core of substrate glass manufacturing lies in a hot-end area, which includes a furnace, a platinum channel, and a forming zone. An average temperature in the entire hot-end area exceeds 1500° C., reaching up to 1650° C. in some sections, posing significant challenges to the stability and the long-term service life of the equipment. An agitation system located in a platinum channel area is primarily responsible for homogenizing the composition and texture of molten glass after high-temperature clarification. With an agitator as a core component, the agitation system performs real-time stretching, shearing, and other operations on the molten glass within an agitation tank through continuous and uniform rotation, thereby achieving high-quality glass output. Currently, the agitation system commonly used in the industry mainly forms a connection channel for the molten glass through a vertically distributed agitation tank and a transition pipe connected to one side. However, the structure has inherent drawbacks. Unilateral injection of the molten glass generates a unidirectional force on rotation of the agitator. The phenomenon becomes more significant as the glass flow rate rises. Generally, in a later stage of production, fatigue deformation of some components of the agitation structure due to prolonged operation further exacerbates abnormal oscillation of the agitator, potentially even leading to equipment safety concerns. Furthermore, unilateral glass injection introduces the problem of viscosity-temperature segregation during an agitation process. Specifically, a higher concentration of denser molten glass flows along the inlet side, which adversely affects the overall homogenization effect of the molten glass.

Therefore, there is a need to provide an agitation structure and an agitation method to address the stability problems in existing agitation systems caused by the unilateral force exerted by the glass fluid on the agitator, and the problem of viscosity-temperature segregation near the inflow side of the molten glass.

### SUMMARY

One or more embodiments of the present disclosure provide an agitation structure, including an agitation inlet pipe and an agitation tank. The agitation tank includes a buffer pool and an agitation container. The agitation container is communicably installed below the buffer pool. The agitation inlet pipe is communicably installed on a side wall of the buffer pool. The agitation tank is provided with an agitator.

One or more embodiments of the present disclosure provide an agitation method of an agitation structure. The agitation method is implemented by the agitation structure and includes: installing an agitation inlet pipe on a buffer pool, and performing a buffering treatment on molten glass flowing into the agitation inlet pipe; directing the molten glass subjected to the buffering treatment into an agitation container through an action of an agitator; and causing the molten glass to flow in a 360° direction through an action of the agitation container.

One or more embodiments of the present disclosure further provide a non-transitory computer-readable storage medium storing computer instructions. When a computer reads the computer instructions in the storage medium, the computer executes the agitation method.

### BRIEF DESCRIPTION OF THE DRAWINGS

To more clearly illustrate the technical solutions in the embodiments of the present disclosure, the drawings used in the embodiments are briefly introduced below. It should be understood that the following drawings only show some embodiments of the present disclosure and therefore should not be considered as limiting the scope. For those skilled in the art, other related drawings can be obtained based on these drawings without creative efforts.

FIG. 1 is a schematic diagram illustrating an agitation structure according to some embodiments of the present disclosure;

FIG. 2 is a schematic diagram illustrating a structure of a specially-shaped agitation tank according to some embodiments of the present disclosure;

FIG. 3 is a schematic diagram illustrating a traditional agitation manner with unilateral molten glass inflow;

FIG. 4 is a schematic diagram illustrating a structure of an agitator with an additional independent top blade according to some embodiments of the present disclosure;

FIG. 5 is an exemplary schematic diagram illustrating an operating principle and function of an agitation structure according to some embodiments of the present disclosure;

FIG. 6 is a schematic diagram illustrating another structure of an agitation tank according to some embodiments of the present disclosure;

FIG. 7 is a schematic diagram illustrating deviation in a horizontal angle of an oblique guide channel according to some embodiments of the present disclosure; and

FIG. 8 is a schematic diagram illustrating a structure of at least two support devices according to some embodiments of the present disclosure.

Description of reference numerals: 1 is an agitation inlet pipe, 2 is an agitation tank, 3 is an agitator, 4 is a drain electrode, 5 is a buffer pool, 6 is an agitation container, 7 is an agitation shaft, 8 is a first agitation blade, 9 is a second agitation blade, 10 is molten glass, 11 is molten glass with viscosity-temperature segregation, 12 is an annular guide plate, 13 is an oblique guide channel, 131 is an inlet end of the oblique guide channel, 132 is an outlet end of the oblique guide channel, 14 is a top plate, 15 is an activity space, 16 is a universal joint, 17 is a telescopic rod.

### DETAILED DESCRIPTION

To make the objectives, technical solutions, and advantages of the embodiments of the present disclosure clearer, the technical solutions in the embodiments of the present disclosure will be clearly and completely described below with reference to the accompanying drawings in the embodiments of the present disclosure. Obviously, the described embodiments are some, but not all, embodiments of the present disclosure. Components of the embodiments of the present disclosure described and illustrated in the accompanying drawings herein may be arranged and designed in various different configurations.

Therefore, the following detailed description of the embodiments of the present disclosure provided in the accompanying drawings is not intended to limit the scope of the present disclosure, but merely represents selected embodiments of the present disclosure. Based on the embodiments in the present disclosure, all other embodiments obtained by those skilled in the art without creative efforts shall fall within the protection scope of the present disclosure.

It should be noted that similar reference numerals and letters denote similar items in the following accompanying drawings. Therefore, once an item is defined in one accompanying drawing, it does not need to be further defined and explained in subsequent accompanying drawings.

In the description of the embodiments of the present disclosure, it should be noted that if terms such as “upper”, “lower”, “horizontal”, and “inner” are used to indicate orientations or positional relationships. The orientations or positional relationships are based on the orientations or positional relationships shown in the accompanying drawings, or are the orientations or positional relationships in which the product of the invention is usually placed when in use. These terms are used merely to facilitate the description of the present disclosure and simplify the description, and do not indicate or imply that the referred apparatus or elements must have specific orientations or be constructed and operated in specific orientations. Therefore, these terms should not be construed as limitations to the present disclosure. In addition, terms such as “first” and “second” are used only for distinguishing description, and should not be construed as indicating or implying relative importance.

In addition, if the term “horizontal” appears, it does not mean that the component must be absolutely horizontal, but may be slightly inclined. For example, “horizontal” only means that its direction is more horizontal relative to “vertical”, and does not mean that the structure must be completely horizontal, but may be slightly inclined.

In the description of the embodiments of the present disclosure, it should also be noted that, unless otherwise explicitly specified and defined, the terms “arranged,” “installed,” “connected,” and “connection” should be interpreted broadly. For example, a connection may be a fixed connection, a detachable connection, or an integral connection; may be a mechanical connection, an electrical connection, or a direct connection, or may be an indirect connection through an intermediate medium, or may be an internal communication between two elements.

Those skilled in the art may understand the specific meanings of the foregoing terms in the present disclosure according to specific situations.

The present disclosure is described in further detail below with reference to the accompanying drawings.

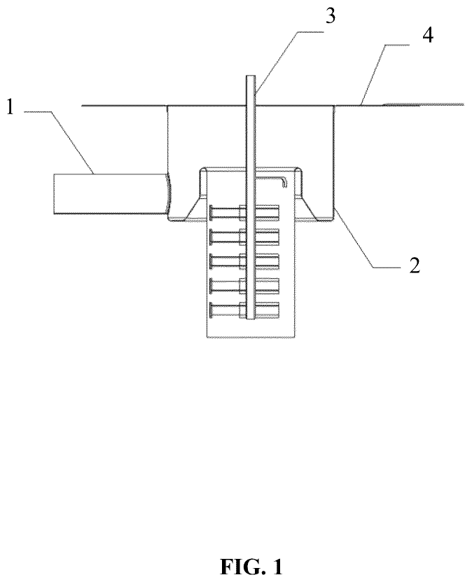

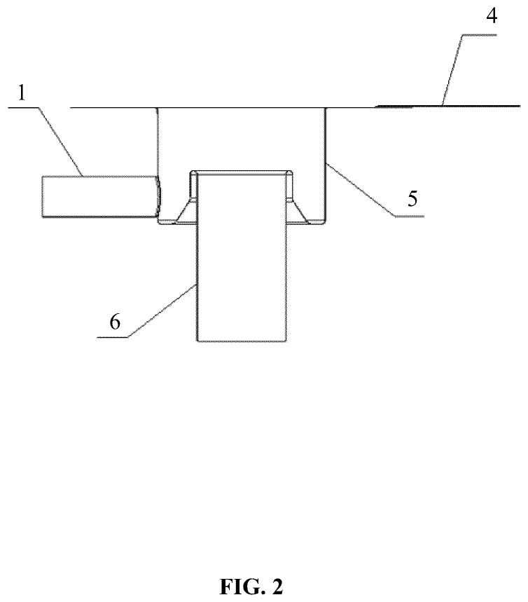

FIG. 1 is a schematic diagram illustrating an agitation structure according to some embodiments of the present disclosure. FIG. 2 is a schematic diagram illustrating a structure of a specially-shaped agitation tank according to some embodiments of the present disclosure.

An agitation structure proposed in the present disclosure, as shown in FIG. 1 to FIG. 2, includes an agitation inlet pipe 1 and an agitation tank 2. The agitation tank 2 includes a buffer pool 5 and an agitation container 6. The agitation container 6 is communicably installed below the buffer pool 5. The agitation inlet pipe 1 is communicably installed on a side wall of the buffer pool 5. The agitation tank 2 is provided with an agitator 3.

The agitation inlet pipe refers to an initial channel through which molten glass enters the agitation structure. The molten glass refers to a molten, viscous liquid formed by melting a plurality of raw materials (e.g., quartz sand, soda ash, limestone, etc.) in a high-temperature melting furnace. A temperature of the molten glass is extremely high, typically between 1300° C. and 1600° C.

In some embodiments, the agitation inlet pipe is made of a refractory material or a platinum alloy capable of withstanding extreme high temperatures.

The agitation tank refers to a core container for agitating the molten glass.

Referring to FIG. 2, FIG. 2 shows a specific structure of the agitation tank 2. The agitation tank 2 mainly includes the buffer pool 5 and the agitation container 6.

The buffer pool is an upper chamber of the agitation tank and has a non-standard shape. A standard shape refers to a shape with a regular geometric outline, strong symmetry, and easy to describe and process using standard formulas, e.g., a circle, a square, etc. In some embodiments, the buffer pool 5 may also be referred to as a specially-shaped buffer pool.

The specially-shaped buffer pool needs to be processed separately, which is formed at one time using a mold, followed by local structural adjustments, and is finally welded to the agitation container 6. Materials of the specially-shaped buffer pool and the agitation container 6 are selected from platinum-rhodium alloy, with an Rh content typically controlled within a range of 10%-25%, which ensures processability of the materials and provides sufficient high-temperature strength.

In some embodiments, the buffer pool may have a plurality of shapes, e.g., a U-shape, a V-shape, a trapezoidal shape, a semi-elliptical shape, etc.

In some embodiments, the buffer pool 5 has a U-shaped structure.

The buffer pool 5 has the U-shaped structure. The specially-shaped buffer pool adopts a circular pipe body, with an overall pipe diameter larger than a pipe diameter of a standard agitation tank (also be referred to as the agitation container). The overall pipe diameter has an oversize of 25% to 60% relative to the pipe diameter of the standard agitation tank. The buffer pool 5 is generally circular, with a cross-section that is an approximately U-shaped rotational body, providing a container function capable of accommodating the molten glass.

The overall pipe diameter refers to a diameter of a pipe body of the buffer pool itself.

The pipe diameter of the standard agitation tank refers to an inner diameter of the agitation container. For example, the overall pipe diameter has an oversize of 25% relative to the pipe diameter of the standard agitation tank. As another example, the overall pipe diameter has an oversize of 40% relative to the pipe diameter of the standard agitation tank. As yet another example, the overall pipe diameter has an oversize of 60% relative to the pipe diameter of the standard agitation tank.

By configuring the buffer pool as the U-shaped structure, the molten glass can smoothly change direction, thereby reducing the generation of unnecessary vortices and fluid resistance. Simultaneously, the U-shaped structure provides a maximum effective volume to accommodate the molten glass.

In some embodiments, the agitation inlet pipe 1 is communicably installed on the side wall of the buffer pool 5. For example, as shown in FIG. 2, the agitation inlet pipe 1 is communicably installed on a left side wall of the buffer pool 5. The agitation inlet pipe 1 may also be communicably installed on other side walls of the buffer pool 5, e.g., a right side wall, a front side wall, etc., and may be set according to actual requirements.

The agitation container is a lower chamber of the agitation tank, configured to provide space for the molten glass that needs to be agitated.

In some embodiments, a diameter of the agitation container 6 is in a range of 330 mm to 380 mm, a diameter of the buffer pool 5 is in a range of 410 mm-600 mm, and a height of the buffer pool 5 is in a range of 160 mm-200 mm.

For example, the diameter of the agitation container 6 is 330 mm, the diameter of the buffer pool is 410 mm, and the height of the buffer pool is 160 mm. As another example, the diameter of the agitation container 6 is 360 mm, the diameter of the buffer pool is 510 mm, and the height of the buffer pool is 170 mm. As yet another example, the diameter of the agitation container 6 is 380 mm, the diameter of the buffer pool is 600 mm, and the height of the buffer pool is 200 mm. The diameter of the agitation container 6, the diameter of the buffer pool 5, and the height of the buffer pool 5 may be set based on actual requirements.

The diameter of the agitation container 6 is generally in a range of 330 mm to 380 mm according to different glass flow rates. A maximum diameter of the specially-shaped buffer pool is generally designed to be in a range of 410 mm to 600 mm relative to the diameter of the agitation container 6. A height of the buffer pool 5 where the molten glass is located is about 160 mm to 200 mm, which may maintain a retention time of about 40 s to 100 s, so that the molten glass overflows to the agitation container 6 after reaching a relatively stable state.

In some embodiments, an installation height of the agitation inlet pipe 1 is lower than an installation height of the agitation container 6.

In some embodiments, an installation height difference between the agitation inlet pipe 1 and the agitation container 6 is in a range of 5 mm-20 mm. For example, the installation height difference between the agitation inlet pipe 1 and the agitation container 6 is 5 mm. As another example, the installation height difference between the agitation inlet pipe 1 and the agitation container 6 is 13 mm. As yet another example, the installation height difference between the agitation inlet pipe 1 and the agitation container 6 is 20 mm. The installation height difference between the agitation inlet pipe 1 and the agitation container 6 may be set based on actual requirements.

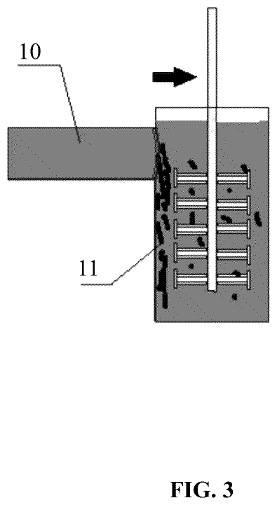

As may be seen from FIG. 2, a top end of the agitation inlet pipe 1 is slightly lower than a top end of the agitation container 6. Considering a pressure loss height formed by the molten glass, the top end of the agitation inlet pipe 1 is generally set 5 mm to 20 mm lower than the top end of the agitation container 6. The configuration allows the molten glass from the agitation inlet pipe 1 to first enter the specially-shaped buffer pool. The molten glass accumulates until it reaches an upper edge of the specially-shaped buffer pool and then overflows uniformly along a circular interface into the agitation container 6. In this case, a unilateral glass pushing force on the agitator 3, similar to that illustrated in FIG. 3, is prevented. FIG. 3 is a schematic diagram illustrating a traditional agitation manner with unilateral molten glass inflow.

As shown in FIG. 3, in the traditional agitation manner with unilateral molten glass inflow, the agitation tank 2 is vertically distributed. The molten glass 10 flows directly into the agitation tank from a lateral pipe on one side, generating a unidirectional pushing force on the agitator 3, which affects the stability of the agitation. Simultaneously, during the agitation process of the molten glass, the unilateral feedstock directly impacts a relatively cool container wall, causing local cooling of the molten glass and an increase in viscosity, thereby forming molten glass 11 with viscosity-temperature segregation as shown in FIG. 3.

The molten glass 11 with viscosity-temperature segregation refers to a portion of molten glass that differs from the majority of the molten glass by having an excessively high viscosity and similarly high density. The abnormal molten glass has an adverse effect on the quality of the overall molten glass.

Therefore, adopting the structure of the specially-shaped buffer pool in the present disclosure can effectively improve the stability issues caused by the unilateral glass pushing force.

The pressure loss height refers to an equivalent liquid column height corresponding to the energy lost due to flow resistance during the transportation of the molten glass.

The circular interface refers to an annular, uniform overflow front formed when the molten glass accumulates in the specially-shaped buffer pool and begins to overflow from a top edge (upper edge) of the specially-shaped buffer pool into the agitation container 6 below.

The unilateral glass pushing force refers to an unbalanced, one-sided impact force generated on original molten glass in the container and the rotating agitator 3 when the molten glass directly rushes into the agitation container 6 from one side (unilaterally) at a high speed.

The installation height of the agitation inlet pipe 1 is lower than the installation height of the agitation container 6, allowing the molten glass to first enter the specially-shaped buffer pool for pretreatment. The configuration eliminates the unilateral glass pushing force and forms uniform circular interface overflow, contributing to achieving high-efficiency homogenization.

The agitator refers to a collective term for all components that perform the agitation action. In some embodiments, the agitator includes an agitation rod (shaft), agitation blades, a drive device, etc.

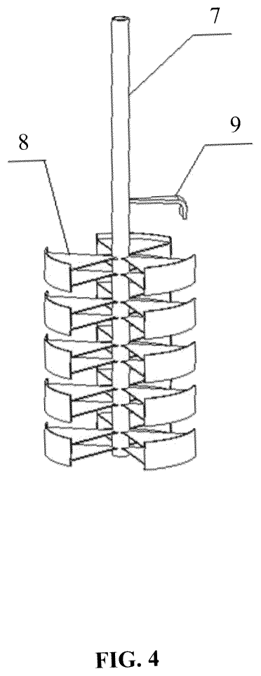

FIG. 4 is a schematic diagram illustrating a structure of an agitator with an additional independent top blade according to some embodiments of the present disclosure.

In some embodiments, as shown in FIG. 4, the agitator 3 includes an agitation shaft 7 and first agitation blades 8. The first agitation blades 8 are installed on the agitation shaft 7.

The agitation shaft refers to a long shaft installed perpendicular to a bottom surface of the agitation container and driven by a motor.

The first agitation blades refer to a plurality of main agitation components installed on the agitation shaft.

In some embodiments, the first agitation blades may include two first agitation blades, or may include a plurality of first agitation blades. The first agitation blades 8 may be fixed to the agitation shaft 7 in a plurality of ways, e.g., welding, flange connection, etc. Merely by way of example, the first agitation blades may include two first agitation blades. The two first agitation blades may be symmetrically welded onto the agitation shaft. The count and fixing ways of the first agitation blades may be set based on actual requirements.

In some embodiments, the first agitation blades include a plurality of first agitation blades. The plurality of first agitation blades 8 are installed on the agitation shaft 7.

In some embodiments, the plurality of first agitation blades 8 may be installed on the agitation shaft 7 in a plurality of ways. For example, the plurality of first agitation blades 8 may be installed on the agitation shaft 7 at equal intervals.

Equal interval installation refers to arranging the plurality of first agitation blades 8 along an axial direction of the agitation shaft 7 with identical vertical spacing distances. In this case, the equal interval installation also includes arranging the plurality of first agitation blades at equal angles in a circumferential direction. For example, as shown in FIG. 4, in the axial direction of the agitation shaft 7, there are 5 sets of first agitation blades 8 arranged in an identical manner. The identical manner includes: in one cross-section, uniformly arranging 3 first agitation blades 8 at 120° intervals; and in the axial direction, arranging 5 first agitation blades 8 with identical vertical spacing distances. The axial direction refers to a length direction of the agitation shaft 7 (typically a vertical direction). The circumferential direction refers to a direction encircling the agitation shaft 7 (typically a horizontal direction). The vertical spacing distance refers to a length of the distance spaced in the axial direction. The equal intervals may include a plurality of vertical spacing distances, e.g., 8 mm, 10 mm, etc. The equal intervals may also include a plurality of included angles, e.g., 45°, 60°, etc. The equal intervals may be set based on experience.

In some embodiments, the plurality of first agitation blades 8 may also be installed on the agitation shaft 7 by staggered installation, variable diameter installation, adjustable angle installation, etc.

By arranging the plurality of first agitation blades at equal intervals, the centrifugal force generated during rotation can be maximally offset, thereby effectively reducing vibration and oscillation during the operation of the agitation structure, which ensures smooth operation with low oscillation and extends the service life of the agitation structure.

In some embodiments, one or more second agitation blades 9 are installed on the agitation shaft 7. Each of the one or more second agitation blades 9 is configured as an inverted L-shape.

The second agitation blade refers to an agitation component installed on the agitation shaft for shearing the fluid.

In some embodiments, as shown in FIG. 4, each of the one or more second agitation blades 9 is configured as the inverted L-shape and includes a vertical arm connected to the agitation shaft 7 and a horizontal arm extending radially outward.

In some embodiments, the one or more second agitation blades may include one second agitation blade or a plurality of second agitation blades. The one or more second agitation blades 9 may be fixed to the agitation shaft 7 in a plurality of ways, e.g., welding, flange connection, etc. The count and fixing manners of the one or more second agitation blades may be set based on actual requirements.

In some embodiments, the one or more second agitation blades 9 include a plurality of second agitation blades 9. The plurality of second agitation blades 9 are installed in the circumferential direction of the agitation shaft 7. A thickness of each of the plurality of second agitation blades 9 is in a range of 8 mm-12 mm.

In some embodiments, the plurality of second agitation blades 9 may be installed in the circumferential direction of the agitation shaft 7 in a plurality of ways. For example, the plurality of second agitation blades 9 may be installed in the circumferential direction of the agitation shaft 7 at equal intervals.

Installing at equal intervals in the circumferential direction refers to the plurality of second agitation blades being uniformly distributed in the circumferential direction surrounding the agitation shaft 7 at identical angular intervals. The equal intervals may be 90°, 120°, etc.

In some embodiments, the plurality of second agitation blades may also be installed on the agitation shaft 7 by staggered installation, variable diameter installation, adjustable angle installation, etc.

In some embodiments, a thickness of each of the plurality of second agitation blades 9 is in a range of 8 mm-12 mm. For example, the thickness of each of the plurality of second agitation blades 9 is 8 mm. As another example, the thickness of each of the plurality of second agitation blades 9 is 10 mm. As yet another example, the thickness of each of the plurality of second agitation blades 9 is 12 mm. The thickness of each of the plurality of second agitation blades 9 may be set based on actual requirements.

In some embodiments, a material of the plurality of second agitation blades is completely consistent with that of a main body structure of the agitator, typically a reinforced platinum-rhodium alloy material, which provides sufficient strength and high erosion resistance. An overall thickness of each of the plurality of second agitation blades reaches 8 mm-12 mm, and the shape is configured as the inverted “L” shape, with a bending direction facing downward to serve a flow guiding function. The overall thickness refers to a total projected thickness of a horizontal arm and a vertical arm of the L-shaped blade, i.e., the thickness of each of the plurality of second agitation blades 9.

The equal intervals installation facilitates low-oscillation stable operation, effectively reducing vibration and wear of the agitation structure. The coordinated arrangement of the plurality of blades at equal intervals creates a uniform, stable, and dead-zone-free high-shear flow field within the agitation container, ensuring the consistency of micro-level homogenization of the molten glass. The blade thickness range of 8 mm-12 mm optimizes shear efficiency to the greatest extent while ensuring sufficient mechanical strength and rigidity of the component, achieving fine dispersion of agglomerates and particles with lower energy consumption, and ultimately realizing high-efficiency homogenization.

For the fresh molten glass that has just overflowed into the agitation container 6, targeted preliminary lateral agitation is required to ensure uniform inflow of the molten glass in the circumferential direction. The present disclosure provides an agitator 3 with a second agitation blades 9 at the top, as shown in FIG. 4, a separate paddle blade (i.e., the second agitation blade 9) is added to a traditional agitator. An agitation length of the second agitation blade 9 is larger than a diameter of the first agitation blade 8 below the second agitation blade 9. A gap from the agitation container 6 is generally designed to be 15 mm, enabling maximized agitation of the overflowed molten glass. The material of the second agitation blade 9 is completely consistent with that of the main body structure of the agitator, typically a reinforced platinum-rhodium alloy material, which provides sufficient strength and high erosion resistance. The overall thickness of each of the plurality of second agitation blades 9 reaches 8 mm-12 mm, and the shape is configured as the inverted “L” shape, with the bending direction facing downward to serve the flow guiding function. A rotation range of the second agitation blade 9 is 80%-90% of a diameter of a standard agitation tank. The second agitation blades 9 are connected to the agitation shaft 7 by welding. In the circumferential direction, one second agitation blade may be arranged, or 2-6 second agitation blades may be arranged at equal intervals. Through the second agitation blades 9 combined with the specially-shaped buffer pool, the molten glass entering the agitation container 6 is fully diverted and agitated, eliminating the molten glass 11 with viscosity-temperature segregation shown in FIG. 3 near the unilateral inflow side.

The independently designed second agitation blades in the upper portion of the agitator have a preliminary flow stabilizing effect on the upper overflowed molten glass, providing a better foundation for the formal agitation and homogenization below. Through the structure of the present disclosure, future agitation equipment and process effects with a larger flow rate, higher stability, and longer lifespan can be achieved.

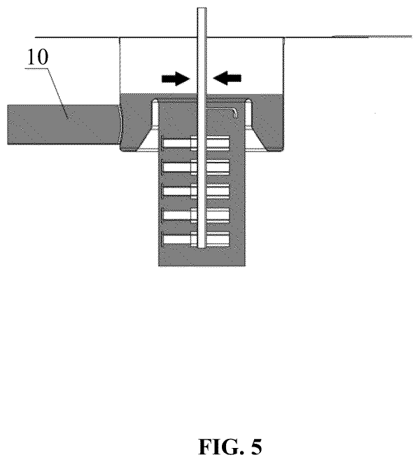

FIG. 5 is an exemplary schematic diagram illustrating an operating principle and function of an agitation structure according to some embodiments of the present disclosure.

The specially-shaped buffer pool, as designed in the present disclosure, ensures a circumferentially uniform and dispersed inflow of the molten glass 10 into the agitation container 6. The lateral force on the agitator 3 also changes from unilateral to symmetrically distributed. Referring to FIG. 3 and FIG. 5, the molten glass 11 with viscosity-temperature segregation basically does not generate a biased force on the agitator 3, but rather a symmetrical force along the circumferential direction, making the overall operation of the agitator more stable. After operating under a large flow rate for more than three years, an oscillation amount of the agitation shaft 7 still does not exceed 2 mm, which will provide sufficient guarantee for the industrial application of subsequent equipment with larger production capacity and longer lifespan reliability. The oscillation amount of the agitation shaft refers to a radial (horizontal) displacement of the agitation shaft during rotation.

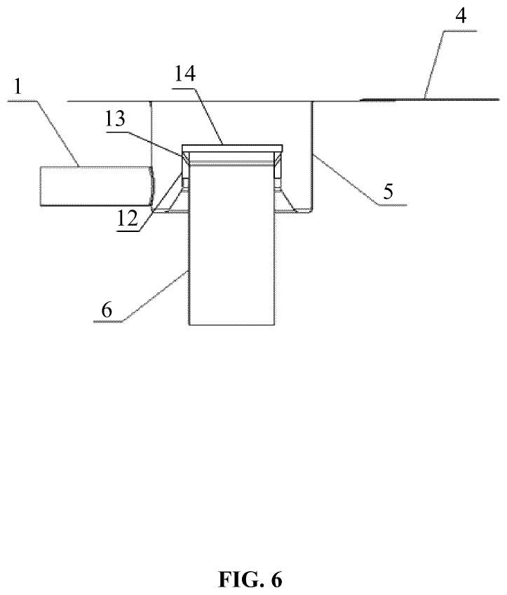

In some embodiments, an annular guide plate is provided at a connection between the buffer pool and the agitation container. More content regarding the part may be found in the corresponding description of FIG. 6.

Referring to FIG. 1, the agitation structure with low oscillation and high-efficiency homogenization, besides the agitation inlet pipe 1, the agitation tank 2, and the agitator 3, further includes drain electrodes 4.

Homogenization refers to a process of making the molten glass reach a highly uniform and consistent state in temperature, chemical composition, and density.

Low-oscillation refers to small radial runout and axial float of the agitation shaft when the agitator rotates at a high speed, e.g., less than 0.1 mm.

High-efficiency refers to achieving the best possible homogenization effect in the shortest possible time with the lowest possible energy input. For example, a traditional agitation structure requires 300 s to achieve a uniformity of 95%, whereas the agitation structure of the present disclosure requires only 150 s.

The drain electrodes refer to elements used for directly heating the molten glass internally.

In some embodiments, the agitation structure includes two sets of drain electrodes 4. An upper set of drain electrodes is provided on an upper sidewall of the agitation tank 2, e.g., provided on an upper half of a cylinder body of the agitation container 6, below a liquid level of the molten glass, but above the one or more second agitation blades 9. A lower set of drain electrodes is provided on a lower sidewall or a bottom of the agitation tank 2, e.g., a bottom of the agitation container 6.

Through the upper and lower sets of drain electrodes, a complete circuit may be formed in the agitation structure, providing current input for the entire agitation tank, thereby heating the molten glass.

The present disclosure proposes the agitation structure with low-oscillation and high-efficiency homogenization. Considering the manner in which the molten glass enters the agitation tank, the original unilateral direct inflow of the molten glass is changed to a buffered and dispersed inflow, thereby changing the unilateral force of the molten glass on the agitator to the uniform force in the circumferential direction, which can effectively reduce the negative impact of the molten glass on the operational stability of the entire agitator. According to the principle, the present disclosure fully considers the uneven force on the agitator by the unilateral inflow of the molten glass into the agitation tank, which affects the long-term stable operation of the agitator. Furthermore, the unilateral inflow of the molten glass easily forms a viscosity-temperature segregation phenomenon near the inlet side, which weakens the homogenization effect. By adding the specially-shaped buffer pool to achieve a force transition of the fluid before entering the agitation tank, and adopting a 360° overflow manner of the molten glass to continuously inject the molten glass into the agitation tank, significant improvement is made to the rotational stability of the entire agitator, providing sufficient guarantee for the long lifespan reliability of the equipment and high-efficiency homogenization under a large flow rate. The configuration enables the uniform force of the molten glass on the agitator in the circumferential direction, significantly reduces abnormal oscillation issues of the agitator during operation, and achieves high-efficiency homogenization for the molten glass with the large flow rate.

FIG. 6 is a schematic diagram illustrating another structure of an agitation tank according to some embodiments of the present disclosure.

In some embodiments, as shown in FIG. 6, an annular guide plate 12 is provided at a connection between the buffer pool 5 and the agitation container 6. A plurality of oblique guide channels 13 are provided on the annular guide plate 12 in a circumferential direction. A top plate 14 is configured to cover the annular guide plate 12.

More details regarding the buffer pool 5 and the agitation container 6 may be found in other contents of the present disclosure (e.g., description in connection with FIG. 1). More details regarding the circumferential direction may be found in other contents of the present disclosure (e.g., description in connection with FIG. 4).

The annular guide plate refers to an annular plate-shaped member provided at the connection between the buffer pool and the agitation container. As shown in FIG. 6, an inner wall of the annular guide plate 12 contacts an outer wall of the agitation container 6. An outer wall of the annular guide plate 12 contacts the buffer pool. The annular guide plate may be made of platinum-rhodium alloy.

In some embodiments, a thickness of the annular guide plate is in a range of 5 mm-50 mm, and a height of the annular guide plate is in a range of 50 mm-80 mm. For example, the thickness of the annular guide plate is 5 mm, and the height of the annular guide plate is 50 mm. As another example, the thickness of the annular guide plate is 25 mm, and the height of the annular guide plate is 65 mm. As yet another example, the thickness of the annular guide plate is 50 mm, and the height of the annular guide plate is 80 mm. The thickness and the height of the annular guide plate may be set based on actual requirements.

The oblique guide channels refer to through holes or channels with inclination angles formed in the annular guide plate 12. The inclination angles include a horizontal angle and a vertical angle.

The horizontal angle refers to a deviation angle relative to a first standard direction corresponding to each of the plurality of oblique guide channels on a horizontal plane. The vertical angle refers to a deviation angle relative to a second standard direction corresponding to each of the plurality of oblique guide channels on a vertical plane. The first standard direction refers to a direction from an inlet end of each of the plurality of oblique guide channels toward a center of the agitation container. The second standard direction refers to a direction vertically from the inlet end of each of the plurality of oblique guide channels toward the ground. The center of the agitation container refers to a geometric center of a cylindrical cross-section of the agitation container.

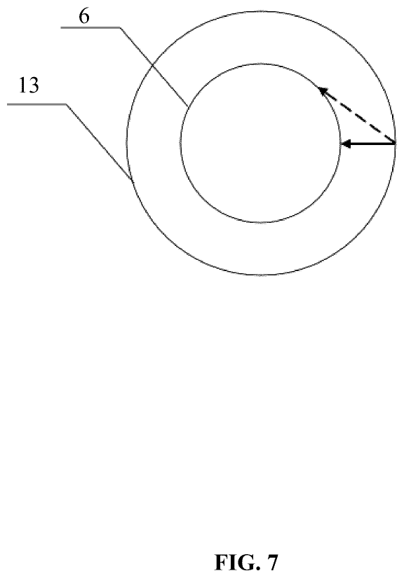

For example, as shown in FIG. 7, FIG. 7 is a schematic diagram illustrating deviation in a horizontal angle of an oblique guide channel according to some embodiments of the present disclosure. A solid arrow represents that an oblique guide channel 13 has no deviation on the horizontal plane, and the inlet end of the oblique guide channel 13 points toward the center of the agitation container 6, resulting in a smaller spiral degree of guided molten glass. A dashed arrow represents that an oblique guide channel 13 has a deviation on the horizontal plane, resulting in a larger spiral degree of the guided molten glass. The inlet end of the oblique guide channel 13 refers to an end located on an outer wall of the oblique guide channel, i.e., a port through which the molten glass flows into from the buffer pool.

Merely by way of example, both the horizontal angle and the vertical angle of the oblique guide channel may be 45°. In this case, the corresponding oblique guide channel may be obtained by drilling holes in the annular guide plate based on a fixed angle. The horizontal angle and the vertical angle may be set based on actual requirements. In some embodiments, a diameter of the oblique guide channel is in a range of 15 mm-30 mm. For example, the diameter of the oblique guide channel is 15 mm. As another example, the diameter of the oblique guide channel is 23 mm. As yet another example, the diameter of the oblique guide channel is 30 mm. The diameter of the oblique guide channel may be set based on actual requirements.

In some embodiments, a plurality of oblique guide channels 13 are uniformly provided on the annular guide plate 12 in the circumferential direction. Uniformly provided means that the plurality of oblique guide channels 13 are arranged at equal angular intervals. For example, if there are eight oblique guide channels, an included angle between every two adjacent oblique guide channels is 45°.

In some embodiments, the plurality of oblique guide channels may be made of platinum-rhodium alloy.

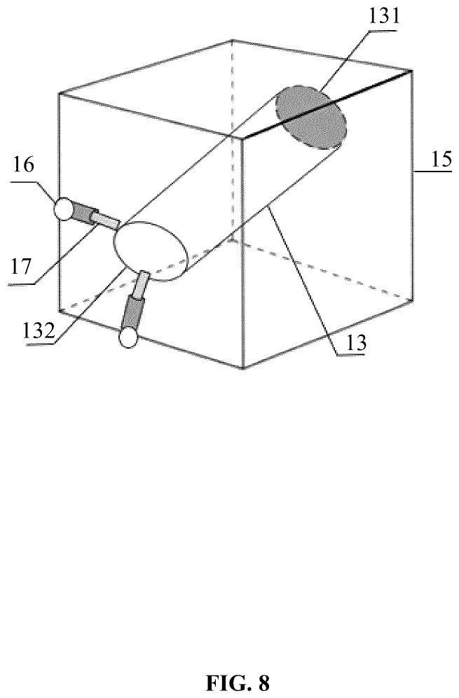

FIG. 8 is a schematic diagram illustrating a structure of at least two support devices according to some embodiments of the present disclosure. FIG. 8 uses one oblique guide channel as an example for explanation.

In some embodiments, as shown in FIG. 8, the inclination angle of the oblique guide channel 13 is adjustable. The oblique guide channel 13 is located in an activity space 15. The inlet end 131 of the oblique guide channel 13 is fixed. An outlet end 132 of the oblique guide channel 13 is supported and adjusted by at least two support devices. Each of the at least two support devices includes a universal joint 16 and a telescopic rod 17. Positions of the at least two support devices are different. The activity space is a cavity pre-machined on the annular guide plate to accommodate the adjustable oblique guide channels. For example, the activity space a cubic cavity defined by the annular guide plate. The cubic cavity may be a cuboid or a cube. A width of the cubic cavity is the same as a thickness of the annular guide plate.

The outlet end refers to an end located on an inner wall of the oblique guide channel, i.e., a port through which the molten glass flows into the agitation container.

The at least two support devices refer to structures for supporting and controlling a spatial position of the outlet end of the oblique guide channel.

The positions of the at least two support devices being different means that the at least two support devices are on different side walls in the activity space.

In some embodiments, a count of the support devices may be two, four, etc. As shown in FIG. 7, when the count of the support devices is two, the two support devices are connected to adjacent side walls in the activity space.

In some embodiments, the support devices may be made of platinum-rhodium alloy.

The universal joint refers to a hinged joint that allows oscillation in a plurality of directions. The universal joint is embedded in the side wall of the activity space, provides directional degrees of freedom, and allows the outlet end to change the inclination angle.

Merely by way of example, the universal joint may be a miniature universal joint. An outer diameter of the miniature universal joint is in a range of 6 mm-10 mm, etc. For example, the outer diameter of the miniature universal joint is 6 mm. As another example, the outer diameter of the miniature universal joint is 8 mm. As still another example, the outer diameter of the miniature universal joint is 10 mm.

The telescopic rod refers to a rod-shaped mechanism capable of changing its own length (e.g., a hydraulic cylinder, an electric push rod, or a lead screw). The telescopic rod connects the outlet end and the universal joint, provides a length degree of freedom, and is configured to push or pull back the outlet end, thereby achieving position control.

Merely by way of example, the telescopic rod may be a miniature telescopic rod. An outer diameter of the miniature telescopic rod is in a range of 6 mm-10 mm, and a telescopic length of the miniature telescopic rod is in a range of 10 mm-20 mm. For example, the outer diameter of the miniature telescopic rod is 6 mm, and the telescopic length of the miniature telescopic rod is 10 mm. As another example, the outer diameter of the miniature telescopic rod is 8 mm, and the telescopic length of the miniature telescopic rod is 15 mm. As yet another example, the outer diameter of the miniature telescopic rod is 10 mm, and the telescopic length of the miniature telescopic rod is 20 mm.

In this case, the oblique guide channel is a structure made of a material having certain ductility (capable of providing deformation required for direction changing) and rigidity (capable of being supported), e.g., platinum-rhodium alloy, nickel-based superalloy, or the like.

Understandably, to prevent the molten glass from flowing into or splashing into the activity space when exiting from the outlet end, a shape of the outlet end of the oblique guide channel may be designed similarly to the second agitation blade 9, fashioned into an inverted L-shape (not shown in the figure above) to guide the flow.

In some embodiments, each of the at least two support devices includes a temperature-resistant drive member. The temperature-resistant drive member is connected to a control center through an optical fiber and receives a control signal. The temperature-resistant drive member is configured to control operating parameters of each of the at least two support devices based on the control signal.

The temperature-resistant drive member refers to a power and execution mechanism capable of operating normally under sustained high-temperature conditions and converting an electrical signal issued by the control center into mechanical motion. In some embodiments, the temperature-resistant drive member is a high-temperature-resistant drive member. For example, the temperature-resistant drive member may be a platinum-iridium alloy thermal expansion actuator, a silicon molybdenum rod thermal expansion actuator, etc.

The optical fiber refers to a communication medium used for transmitting the control signal between the control center and the temperature-resistant drive member. The optical fiber may transmit the control signal issued by the control center to the temperature-resistant drive member, and simultaneously receive status data fed back by the temperature-resistant drive member to the control center, so that the control center adjusts the control signal in real time based on the status data. The status data refers to relevant data after adjusting the at least two support devices based on the operating parameters.

In some embodiments, a power supply is provided to the high-temperature-resistant drive member via a platinum-rhodium alloy wire, and the platinum-rhodium alloy wire and the optical fiber pass through a same ceramic protection tube to avoid high-temperature loss from separate wiring. The ceramic protection tube is embedded in the annular guide plate and connected to the power supply and the control center located in an external ambient temperature environment.

The control center refers to a computer or programmable logic controller (PLC) system located outside the agitation structure and is configured to generate a control instruction.

The control signal refers to a control instruction for controlling operation of the temperature-resistant drive member.

The operating parameters refer to variables capable of being directly changed by the temperature-resistant drive member, thereby affecting a spatial posture of the oblique guide channel. In some embodiments, the operating parameters include a direction of the universal joint, a telescopic length of the telescopic rod, etc. The direction of the universal joint refers to a specific angle of the universal joint.

In some embodiments, the operating parameters may be acquired by a sensor installed on each of the at least two support devices. For example, the direction of the universal joint is acquired by a shaft angle encoder, the telescopic length of the telescopic rod is acquired by a linear displacement sensor, etc.

By connecting the temperature-resistant drive member and the control center through the optical fiber, the temperature-resistant drive member ensures long-term stable operation under high temperatures, while fiber optic communication avoids electromagnetic interference and overcomes the limitations of manual operation in high-temperature conditions, facilitating remote automated control. Through precise adjustment of the direction of the universal joint and the telescopic length of the telescopic rod, the swirling and distribution state of the molten glass can be accurately arranged, contributing to the achievement of high-efficiency homogenization.

The combination of the universal joint and the telescopic rod facilitates the spatial angle adjustment of the plurality of oblique guide channels. The cubic cavity provides the necessary degrees of freedom for the adjustment of the oblique guide channel, ensuring the smooth realization of the adjustment function.

The top plate refers to a plate-shaped structure used for covering the agitation container to prevent the molten glass from flowing over the annular guide plate when a liquid level of the molten glass is too high. The top plate may be made of platinum-rhodium alloy.

By providing the annular guide plate and the top plate, when the liquid level of the molten glass in the buffer pool is sufficiently high (reaching a height of the plurality of oblique guide channels of the annular guide plate), the molten glass overflows and forms a spiral flow through the plurality of oblique guide channels, and changes from vertical overflow to oblique spiral descent, thereby achieving preliminary mixing in advance and reducing subsequent agitation load.

The present disclosure provides an agitation method of an agitation structure. The agitation method is implemented by the agitation structure. More details regarding the agitation structure may be found in other contents of the present disclosure (e.g., descriptions in connection with FIG. 1-FIG. 8). The agitation method includes the following operations.

In operation 1, the agitation inlet pipe 1 may be installed on the buffer pool 5, and a buffering treatment may be performed on the molten glass flowing into the agitation inlet pipe 1.

In operation 2, the molten glass subjected to the buffering treatment may be directed into the agitation container 6 through an action of the agitator 3.

In operation 3, the molten glass may be caused to flow in a 360° direction to achieve agitation through an action of the agitation container 6.

More details regarding the agitation inlet pipe 1, the agitator 3, the buffer pool 5, and the agitation container 6 may be found in other contents of the present disclosure (e.g., descriptions in connection with FIG. 1-5).

In some embodiments, the buffering treatment may include: providing the buffer pool 5 between the agitation inlet pipe 1 and the agitation tank, and using the buffer pool 5 to perform the buffering treatment of a flow velocity and a flow direction of columnar molten glass flowing unilaterally into the agitation inlet pipe 1. The buffering treatment of the flow velocity and the flow direction includes: lowering a height of the agitation inlet pipe 1 to below an upper edge of the agitation container and pre-providing the buffer pool 5, thereby allowing that the molten glass, before flowing into the agitation container, is first buffered by the buffer pool 5 and then flows into the agitation container. The buffer pool 5 may accommodate approximately 50 kg-150 kg of the molten glass. Accumulation of the molten glass in the buffer pool 5 may achieve natural uniform flow of the molten glass, preventing the molten glass from directly flowing into the agitation container and instead forming a horizontally distributed circulating flow in an upper portion thereof.

In some embodiments, after the circulating flow accumulates and then overflows, the molten glass flows into the agitation container in a 360° direction. The agitation container 6 performs flow state stabilization treatment again on the just-overflowed molten glass using a local agitation manner. A flow rate of the molten glass is in a range of 1000 kg/h-1300 kg/h. A temperature of the molten glass is controlled at 1400°C.-1460°C. A flow velocity of the columnar molten glass flowing unilaterally is in a range of 3 mm/s-6 mm/s. For example, the flow rate of the molten glass is 1000 kg/h. The temperature of the molten glass is controlled at 1400° C. The flow velocity of the columnar molten glass flowing unilaterally is 3 mm/s.

In some embodiments, the agitation method is executed by a control center, and further includes: determining operating parameters of at least two support devices based on monitoring data and a system operating parameter; and generating a control signal based on the operating parameters and sending the control signal to a temperature-resistant drive member.

For descriptions of the control center, the support device, the operating parameter, the control signal, and the temperature-resistant drive member, refer to related content in FIG. 8.

The monitoring data refers to related data of the monitored agitation structure.

In some embodiments, the monitoring data may include a temperature distribution of the molten glass, an oscillation amount of the agitation shaft, a bottom pressure of the agitator, an agitation duration, etc.

The temperature distribution of the molten glass refers to a set of temperatures of the molten glass at different spatial positions inside the agitation container.

The bottom pressure of the agitator refers to a hydrostatic pressure of the molten glass acting on a bottom of the agitation container, which is determined by a liquid level height and a density of the molten glass.

The agitation duration refers to a time elapsed from a start of a current agitation process to now.

In some embodiments, the control center may obtain the monitoring data through sensors installed in the agitation structure. For example, the control center may obtain the temperature distribution of the molten glass through a high-temperature optical fiber sensor installed on an inner wall of the agitation container 6, obtain the oscillation amount of the agitation shaft 7 through a micro-displacement sensor installed at a top of the agitation shaft 7, and obtain the bottom pressure of the agitator 3 through a pressure sensor installed at the bottom of the agitation container 6.

In some embodiments, the control center includes an internal timer, which is configured to record start and stop times of the agitation structure, thereby obtaining the agitation duration.

The system operating parameter refers to a current operating parameter of the agitation structure.

In some embodiments, the system operating parameter includes a current operating parameter of each of the at least two support devices, rotation speeds of the first agitation blades 8 and the second agitation blades 9, a temperature provided by the drain electrodes 4, etc. More details regarding the first agitation blades 8, the second agitation blades 9, and the drain electrodes 4 may be found in other contents of the present disclosure (e.g., descriptions in connection with FIG. 1-5). The rotation speeds of the first agitation blades 8 and the second agitation blades 9 include a count of rotations per minute of each of the two sets of agitation blades, which may be obtained through a speed sensor, a rotary encoder, etc. The temperature provided by the drain electrodes 4 refers to a temperature provided and maintained by the drain electrodes for the molten glass flowing through it by heating. The temperature provided by the drain electrodes 4 may be set manually or obtained through measurement. More details regarding the drain electrodes 4 may be found in other contents of the present disclosure (e.g., description in connection with FIG. 1).

In some embodiments, the control center may determine the operating parameters of each of the at least two support devices through an adjustment model based on the monitoring data and the system operating parameter.

The adjustment model refers to a model for determining the operating parameters of the support device. In some embodiments, the adjustment model may be a machine learning model. For example, the adjustment model may be a neural network (NN), a deep neural network (DNN), or any other feasible model structure.

In some embodiments, an input of the adjustment model may include the monitoring data and the system operating parameter, and an output may include the operating parameters of the support device.

In some embodiments, the control center may construct the adjustment model by training with a large number of training samples and training labels corresponding to the training samples. In some embodiments, the control center may obtain a plurality of training data sets, and each training data set includes a training sample and a training label corresponding to the training sample. The control center may perform a plurality of rounds of iterations. At least one round of iterations includes: selecting one or more training samples from the training data set, inputting the one or more training samples with the training labels into an initial adjustment model to obtain a result output by the initial adjustment model, substituting the training labels of the one or more training samples and the result of the initial adjustment model into a preset loss function, and iteratively updating parameters of the initial adjustment model through gradient descent or other manners based on a value determined by the loss function. When a preset condition is met, the model training is completed, and a trained adjustment model is obtained.

The preset condition may be the loss function converging, a count of iterations reaching a threshold, etc.

In some embodiments, the control center may construct a plurality of training samples and corresponding training labels through a plurality of sets of experiments based on historical data, thereby obtaining the plurality of training data sets. In some embodiments, each set of experiments includes the following. The control center may set an initial system operating parameter, control the agitation structure based on the initial system operating parameter, obtain monitoring data at a preset time, obtain a homogenization degree of the molten glass after agitation is completed, and use the homogenization degree of the molten glass obtained at this time as an initial homogenization degree. The control center may control the agitation structure again based on the initial system operating parameter, obtain the monitoring data at the preset time, randomly adjust the operating parameters of the support device, control the agitation structure based on the adjusted operating parameters, and obtain the homogenization degree of the molten glass after agitation is completed. The control center may keep other conditions unchanged, adjust the operating parameters a plurality of times to obtain homogenization degrees of a plurality of types of molten glass until the obtained homogenization degrees of the molten glass reach a preset count; use the initial system operating parameter and the monitoring data at the preset time as the training sample, sort all the homogenization degrees of the molten glass, and take operating parameters of the support device corresponding to a homogenization degree with the highest value as the training label corresponding to the training sample. If the value of the initial homogenization degree is the highest, there is no need to adjust the operating parameters of the support device.

In some embodiments, the preset time may be a preset determined agitation duration, e.g., 10 min. The preset count may be preset determined based on experience. The homogenization degree of the molten glass refers to a degree of consistency of chemical composition, temperature field, and viscosity in various regions inside the molten glass, reflecting a defect degree of the molten glass. A higher homogenization degree indicates a lower defect degree of the molten glass. The control center may obtain an image of the molten glass through a camera, and perform image processing on the image of the molten glass to obtain the homogenization degree of the molten glass.

In some embodiments, the control center may generate the control signal based on the operating parameters and send the control signal to the temperature-resistant drive member. The temperature-resistant drive member may adjust the operating parameters of the support device to values corresponding to the operating parameters included in the control signal.

In some embodiments of the present disclosure, by using the trained machine learning model to determine the operating parameters of the support device, accurate adjustment of the support device can be achieved, improving efficiency and accuracy of support adjustment.

In some embodiments of the present disclosure, by considering the monitoring data and the system operating parameter to adjust the operating parameters of the support device, the operating parameters of the support device can be dynamically optimized, and faults can be prevented in real time, thereby ensuring a process goal of 360° uniform flow of the molten glass.

An embodiment of the present disclosure provides an agitation structure with low-oscillation and high-efficiency homogenization, including an agitation inlet pipe (1) and an agitation tank (2). The agitation tank (2) includes a buffer pool (5) and an agitation container (6). The agitation container (6) is communicably installed below the buffer pool (5). The agitation inlet pipe (1) is communicably installed on a wall of the buffer pool (5). The agitation tank (2) is provided with an agitator (3).

In some embodiments, a plurality of first agitation blades (8) are provided, and the plurality of first agitation blades (8) are installed on the agitation shaft (7) at equal intervals.

In some embodiments, a plurality of second agitation blades (9) are provided, and the plurality of second agitation blades (9) are installed in a circumferential direction of the agitation shaft (7) at equal intervals. A thickness of each of the plurality of second agitation blades (9) is in a range of 8 mm-12 mm.

An embodiment of the present disclosure provides an agitation method of an agitation structure with low-oscillation and high-efficiency homogenization, using the agitation structure with low-oscillation and high-efficiency homogenization, including: installing the agitation inlet pipe (1) on the buffer pool (5), and performing a buffering treatment on molten glass flowing into the agitation inlet pipe (1); directing the molten glass subjected to the buffering treatment into the agitation container (6) through an action of the agitator (3); and causing the molten glass to flow in a 360° direction to achieve agitation through an action of the agitation container (6).

An embodiment of the present disclosure provides a non-transitory computer-readable storage medium storing computer instructions. When a computer reads the computer instructions in the storage medium, the computer executes the agitation method.

The foregoing descriptions are merely preferred embodiments of the present disclosure, and are not intended to limit the present disclosure. For those skilled in the art, the present disclosure may have various modifications and changes. Any modifications, equivalent replacements, improvements, etc., made within the spirit and principle of the present disclosure shall be included within the protection scope of the present disclosure.

What is claimed is:

1. An agitation structure, comprising an agitation inlet pipe and an agitation tank, wherein the agitation tank includes a buffer pool and an agitation container; the agitation container is communicably installed below the buffer pool, the agitation inlet pipe is communicably installed on a side wall of the buffer pool; and the agitation tank is provided with an agitator.

2. The agitation structure of claim 1, wherein the agitator includes an agitation shaft and first agitation blades, and the first agitation blades are installed on the agitation shaft.

3. The agitation structure of claim 2, wherein the first agitation blades include a plurality of first agitation blades, and the plurality of first agitation blades are installed on the agitation shaft.

4. The agitation structure of claim 2, wherein one or more second agitation blades are installed on the agitation shaft, and each of the one or more second agitation blades is configured as an inverted L-shape.

5. The agitation structure of claim 4, wherein the one or more second agitation blades include a plurality of second agitation blades, the plurality of second agitation blades are installed in a circumferential direction of the agitation shaft, and a thickness of each of the plurality of second agitation blades is in a range of 8 mm-12 mm.

6. The agitation structure of claim 1, wherein an installation height of the agitation inlet pipe is lower than an installation height of the agitation container.

7. The agitation structure of claim 6, wherein an installation height difference between the agitation inlet pipe and the agitation container is in a range of 5 mm-20 mm.

8. The agitation structure of claim 1, wherein an annular guide plate is provided at a connection between the buffer pool and the agitation container, a plurality of oblique guide channels are provided on the annular guide plate in a circumferential direction, and a top plate is configured to cover the annular guide plate.

9. The agitation structure of claim 8, wherein an inclination angle of each of the plurality of oblique guide channels is adjustable, the plurality of oblique guide channels are located in an activity space, an inlet end of each of the plurality of oblique guide channels is fixed, and an outlet end of each of the plurality of oblique guide channels is supported and adjusted by at least two support devices; wherein,
each of the at least two support devices includes a universal joint and a telescopic rod;
positions of the at least two support devices are different; and
the activity space is a cubic cavity defined by the annular guide plate.

10. The agitation structure of claim 9, wherein each of the at least two support devices includes a temperature-resistant drive member; the temperature-resistant drive member is connected to a control center through an optical fiber and receives a control signal; the temperature-resistant drive member is configured to control operating parameters of each of the at least two support devices based on the control signal, wherein the operating parameters include a direction of the universal joint and a telescopic length of the telescopic rod.

11. The agitation structure of claim 1, wherein a diameter of the agitation container is in a range of 330 mm-380 mm, a diameter of the buffer pool is in a range of 410 mm-600 mm, and a height of the buffer pool is in a range of 160 mm-200 mm.

12. The agitation structure of claim 1, wherein the buffer pool is U-shaped.

13. An agitation method of an agitation structure, wherein the agitation method is implemented by the agitation structure and comprises:
installing an agitation inlet pipe on a buffer pool, and performing a buffering treatment on molten glass flowing into the agitation inlet pipe;
directing the molten glass subjected to the buffering treatment into an agitation container through an action of an agitator; and
causing the molten glass to flow in a 360° direction through an action of the agitation container.

14. The agitation method of claim 13, wherein the agitation method, executed by a control center, further comprises:
determining operating parameters of at least two support devices based on monitoring data and a system operating parameter; and
generating a control signal based on the operating parameters and sending the control signal to a temperature-resistant drive member.

15. A non-transitory computer-readable storage medium storing computer instructions, wherein when a computer reads the computer instructions in the storage medium, the computer executes the agitation method according to claim 13.
